(19) United States
(12) Patent Application Publication
(10) Pub. No.: US 2007/0116381 A1
(43) Pub. Date: May 24, 2007

(54) Method for deformable registration of images

(76) Inventor: Ali Khamene, Princeton, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/545,833

(22) Filed: Oct. 11, 2006

Related U.S. Application Data
(60) Provisional application No. 60/728,224, filed on Oct. 19, 2005.

(51) Int. Cl. G06K 9/36

(52) U.S. Cl. 382/276

(57) ABSTRACT

A method for registration of two image data sets. The method includes: compartmentalizing a first one of the two image data sets into a plurality of regions with each one of such regions having a presumed but unknown spatially corresponding region in the other one of the two image data sets. For each one of the regions in the first one of the two image data sets and for the presumed spatially corresponding one of the regions in the other one of the two image data set an energy function related to the degree such two regions match one another is defined. The method minimizes the sum of the energy functions defined for each one of the regions in the first one of the two image data sets and for the corresponding one of the regions in the other one of the two image data set by deforming the image data set of such region in the other one of the image data. Energy functions for each region are defined separately. For cases where no explicit correspondence exists the energy function is defined based global statistics of the corresponding regions, ignoring spatial dependency.

### CROSS REFERENCE TO RELATED APPLICATION

This application claims priority from U.S. Provisional application Ser. No. 60/728,224 filed on Oct. 19, 2005, which is incorporated herein by reference.

### TECHNICAL FIELD

This invention relates generally to the registration of images and more particularly to the deformable registration of images.

### BACKGROUND

As is known in the art, registration of images has a wide range of applications. One application is in medical imaging. Registration of pairs of images (2D or 3D) has been extensively studied for medical images, see for example Maintz, J. B. A., Veirgerver, A survey of medical image registration, Medical Image Analysis, 2(1),1-36, 1998.

For the most of the approaches, the main assumption is that warping functions should be continuous, smooth and invertible, so that every point in image one (fixed) maps to exactly one point in image two (moving), and vice-versa. Such smooth, invertible functions are known as diffeomorphisms. Diffeomorphism can be enforced (but not guaranteed) through regularization of the dense deformation field assuming of elastic (see Bajscy R., Lieberson R. and Reivich M., A computerized system for the elastic matching of deformed radiographic images to idealized atlas images, J. Comput. Assis. Tomogr., 7:618-625, 1983), viscous fluid (see Christensen G. E., Joshi S. C., and Miller M., volumetric transformation of brain anatomy, IEEE Trans. Medical Image, 16:864-877, 1997, or splines (see Rueckert D., Frangi A. and Schnabel J., Automatic construction of 3D statistical deformation models using non-rigid deformation,. In MICCAI, pages 77-84, 2001 properties. Diffeomorphic transformations maintain topology and guarantee that connected sub-regions remain connected. The main problem arises, when there are no correspondences available. When dealing with medical images, for example, image from abdominal area of a patient taken at two time points, it is foreseeable that there would not be explicit correspondences for all the points within the sets. This in turn causes strong violation of the intensity similarity and failure of methods which are assuming and enforcing these. There are numerous examples for this case. Let us take two sets of MR scans of same patient before and after surgery where a tumor is present in the first and not in the second image. Another example that happens very frequently is the CT images of male pelvic region for prostate cancer therapy. Rectum, bladder, and intestine content change drastically for one therapeutic session to another makes the process of establishing correspondences impossible and more importantly meaningless. For all these cases, any regularization on the erroneous deformation field caused from naive similarity metric enforcing a complete match, results in serious error on parts of the image even places, where the correspondences can be established. Regularizing the flow causes erroneous results to disperse to other parts as well.

### SUMMARY

In accordance with the present invention, a method is provided for registration of two image data sets. The method includes compartmentalizing a first one of the two image data sets into a plurality of regions with each one of such regions having a corresponding region in the other one of the two image data sets. For each one of the regions in the first one of the two image data sets and for the corresponding one of the regions in the other one of the two image data set, the method computes an energy function related to the degree such two regions match one another. The method minimizes the sum of the energy functions for each one of the regions in the first one of the two image data sets and for the corresponding one of the regions in the other one of the two image data set by deforming the image data set of such region in the other one of the image data set where the energy functions for each region is defined separately.

With such method, prior information regarding the parts (i.e., regions) of the images where correspondence and conventional similarity could be violated is obtained. The method uses prior spatial knowledge of such regions on one of the images. The method registers the two image data sets and at the same time propagates the specified region boundaries from one image data set to the other, while trying to preserve the diffeomorphic property of the field all over the image.

The method deals with this kind of scenarios through a framework that requires rough spatial knowledge of areas, where correspondences cannot be found. The method incorporates a constraint replacing image similarity on parts, where correspondence cannot be established. Using this, the method avoids having penalizing effect on the deformation field on those areas. The constraint could be realized, similar to a segmentation approach, through computation of the probability of the intensity belonging to a certain distribution.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flow diagram of a process used in the registration of deformable images in accordance with the invention;

FIGS. 2A and 2B are sketches of a baseline image (i.e., a fixed image data set) and a current image (i.e., a moving data set), the method of FIG. 1 being used to register different regions in the moving data set with corresponding regions in the fixed data set in accordance with the invention.

Like reference symbols in the various drawings indicate like elements.

### DETAILED DESCRIPTION

In the deformable registration problem, we are given two intensity images I_{f} (i.e., fixed that is a prior or baseline image) and Iₘ (i.e., moving that is a current image which is to be deformed to match the fixed image) over the space Ω, where an unknown transformation T:Ω→Ω has to be recovered. In order to solve this problem, there should be a spatial metric available to measure intensity dissimilarity between the two images. Equation 1 shows an energy functional that has to be minimized with respect to the transformation T.

$${E}_{image} ( T ) = {\int }_{Ω} M ( {I}^{f} ( x ) , {I}^{m} ( T ( x ) ) ) ⅆ x , \qquad ( 1 )$$

where x=[x y z]εΩ for three dimensional images, M ( . , . ) estimates the (dis) similarity. Since, the equation 1 is ill-conditioned, we need to consider another set of constraints, which regularize the transformation T. Equation 2 shows an energy functional for the diffusion regularization.

$${E}_{reg} ( T ) = {\int }_{Ω} trace ( ( I - J ( T ( x ) ) ) {( I - J ( T ( x ) ) )}^{′} ) ⅆ x \qquad ( 2 )$$

Finally, concurrent minimization of the two equations delivers the solution, as follows:

$$\hat{T} = arg {min}_{T} ( {E}_{image} ( T ) + α {E}_{reg} ( T ) ) . \qquad ( 3 )$$

where α is a parameter defining the degree of regularization applied over the deformation field and hat (ˆ) denotes the estimate for the variable. If we assume that images are mono-modal, where the brightness constancy constraint holds, we can use optical flow framework for computing the registration parameters. In this framework, since we are concerned with flow, we re-formulate the transformation T as T(x)=x+u, where u is the flow. Furthermore, replacing M with sum of square differences, transforms the equation 3, as follows:

$$\begin{matrix}\hat{u} = arg min {\int }_{Ω} ( {\vert {I}^{f} ( x ) - {I}^{m} ( x + u ) \vert}^{2} ) ⅆ x + \\ α {\int }_{Ω} ( {\vert ∇ {u}_{x} \vert}^{2} + {\vert ∇ {u}_{y} \vert}^{2} + {\vert ∇ {u}_{z} \vert}^{2} ) ⅆ x\end{matrix} \qquad ( 4 )$$

where u=[uₓ, u_{y}, u_{z}]^{T}. Equation 4 is a non-linear one with respect to u. Solution must satisfy a set of Euler-Lagrange equations, which can be solved using an iterative scheme.

In some application, we need to deal with images, in which for some parts no correspondences can be established. Enforcing both geometrical and radiometrical correspondences, as in it is done in sum of square difference in equation 4 is too penalizing and cause serious errors. In these cases, we need to apply much softer constrains. One feasible constrain is to consider that the intensities of these corresponding parts are belonging to a known probability density function. This is a rather global constraint defined over the specific parts of the image, and has no specificity on the local flow field over that area. Let us assume that Φᵢ for iε[0, n−1] are non-overlapping subsets of Ω, where the intensity probability density function, i.e. pdf is defined as pᵢ. We can then define an energy function that constrains the deformation field based on the either pre-defined pdf or estimated pdf from the pre-defined compartmentalization step, as follows:

$${E}_{seg} ( T ) = - {\sum }_{i} {\int }_{{Φ}_{i}} log ( {p}_{i} ( {I}^{m} ( x + u ) ) ⅆ x . \qquad ( 5 )$$

In special case, where pi is a Gaussian distribution, the equation 5 is constraining the flow field in a way that the intensity of the area defined by Φᵢ remain close to the mean of the distribution. In one scenario, the pdf for each region can be estimated using the intensity histograms of those regions specified on the I_{f}, in another scenario pdfs could be known as a priori.

Here, the method incorporates the spatial soft constraints on the parts of the image, as it is described above into the optical flow framework. The motivation is to compensate for the fact that the brightness constancy constraint and diffeomorphism do not hold on specific parts of the image. Penalizing the flow field to provide accurate correspondences as it is done in equation 4, does have an adverse effect and results in an erroneous mapping. Deformation field can be extracted using the following equation:

$$\begin{matrix}\hat{u} = arg {min}_{u} {\int }_{Ω - {⋃}_{i} {Φ}_{i}} ( {\vert {I}^{f} ( x ) - {I}^{m} ( x + u ) \vert}^{2} ) ⅆ x - \\ β {\int }_{{⋃}_{i} {Φ}_{i}} log ( {p}_{i} ( {I}_{m} ( x + u ) ) ) ⅆ x + \\ α {\int }_{Ω} ( {\vert ∇ {u}_{x} \vert}^{2} + {\vert ∇ {u}_{y} \vert}^{2} + {\vert ∇ {u}_{z} \vert}^{2} ) ⅆ x\end{matrix} \qquad ( 6 )$$

where ∪ᵢΦᵢ denotes the union of Φᵢ's, and α, β>0. If pᵢ is a Gaussian distribution β is one, otherwise, we choose an experimental value close to one. Thus, the second term in equation

$$( i . e . , β {\int }_{{⋃}_{i} {Φ}_{i}} log ( {p}_{i} ( {I}_{m} ( x + u ) ) ) ⅆ x ) \qquad ( 6 )$$

represents the sum of the energy functions for Ui each one of the regions in the first one of the two image data sets and for the corresponding one of the regions in the other one of the two image data set by deforming the image data set of such region in the other one of the image data set where the energy functions for each region is defined separately.

According the calculus of variation, the minimizer of the equation in 6 must fulfill the Euler-Lagrange equations:

$$\begin{matrix}( {I}^{f} ( x ) - {I}^{m} ( x + u ) ) {I}_{x}^{m} ( x + u ) + αΔ {u}_{x} & for x ∈ Ω - {⋃}_{i} {Φ}_{i} \\ \frac{1}{{p}_{i} ( {I}_{m} ( x + u ) )} {p}_{i}^{′} ( {I}_{m} ( x + u ) {I}_{m}^{x} ( x + u ) ) + αΔ {u}_{x} & for x ∈ {Φ}_{i}\end{matrix} \qquad ( 7 )$$

where uₓ, u_{y}, and u_{z} are the components of u and Δ denotes Laplacian operation. By changing of the subscripts of Iₓ^{m}(x+u) and ∇uₓ to y and z, we get additional equations for the three dimensional case. The equation (7) can be solved using a fixed point iteration scheme that continually solves for updated of the deformation field in a multi-resolution setting.

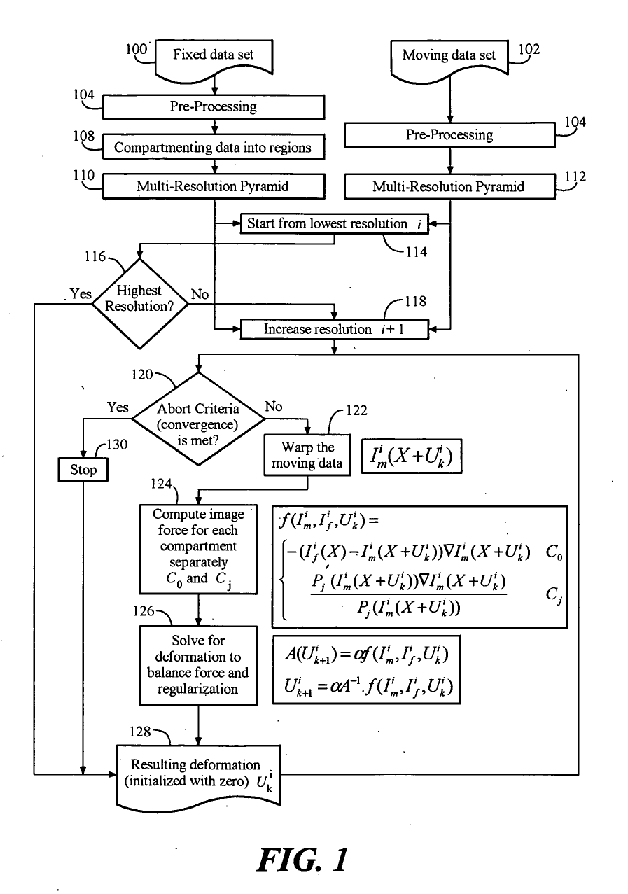

Referring to FIG. 1, the process is as follows:

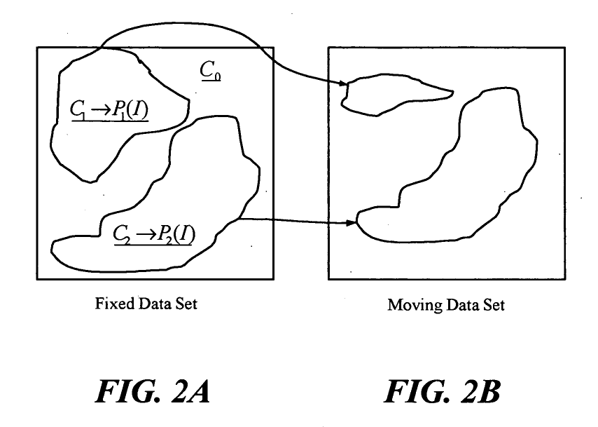

The method obtains the fixed data set and the moving data set, Step 100 and 102. Next, conventional pre-processing (such as smoothing, de-noising, etc) is performed on both the fixed data set and the moving data set, Steps 104 and 106. Next, the fixed data is compartmentalized (i.e., segmenting) into regions by, for example, any known manual or automatic contouring techniques, as for example using a digital pen to outline the regions of interest, Step 108. For example in FIG. 2A one region C₁ having a probability density of pᵢ(I) may for example be the bladder and another, C₂, probability density of p2 (I) the rectum. The regions C₀ are other things in the image. FIG. 2B shows the two regions (i.e., the rectum and the bladder) in the moving data. The images may be obtained with any conventional imaging equipment, such as CT, MRI, X-ray apparatus, not shown, and the process described herein performed by a computer program stored in a memory of the processor therein.

Next, multi-resolution pyramid of both fixed and moving data sets are set up, Steps 110 and 112. Next, the process starts from the lowest resolution i until the highest resolution is reached, Step 114. Thus, since the first data set is not at the highest resolution, the process increases the resolution by 1, i.e., i+1. Step 118. The process then determines whether there is convergence and if not, the process is aborted (i.e., stopped). Steps 120 and 130. If there is convergence the moving data is warped according to the k th iteration deformation uₖⁱ to Iₘⁱ(x+uₖⁱ), Step 122. Any image transformation method maybe used such as that outlined in the following publications Digital Image Warping, George Wolberg, IEEE Computer Society Press, Los Alamitos, Calif., 1990.

Next, the process computes the image force for each compartment separately Cⱼ is for the compartment with known intensity distribution of Pⱼ and C₀ for elsewhere and, Step 124

$$f ( {I}_{m}^{i} , {I}_{f}^{i} , {u}_{k}^{i} ) = \{ \begin{matrix}- ( {I}_{f}^{i} ( x ) - {I}_{m}^{i} ( x + {u}_{k}^{i} ) ) ∇ {I}_{m}^{i} ( x + {u}_{k}^{i} ) & for {C}_{0} \\ \frac{\partial {p}_{j} / \partial {I}_{m}^{i} ( {I}_{m}^{i} ( x + {u}_{k}^{i} ) ) {∇}_{m}^{i} ( x + {u}_{k}^{i} )}{{p}_{j} ( {I}_{m}^{i} ( x + {u}_{k}^{i} ) )} & for {C}_{j}\end{matrix} \qquad ( 8 )$$

Next, (Step 126) the process solves for deformation to balance force in accordance with:
Auₖ₊₁ⁱ=αf(IₘⁱI_{f}ⁱ,uₖⁱ)
uₖ₊₁ⁱ=αA⁻¹f(Iₘⁱ,I_{f}ⁱuₖⁱ) (9)
where A is a linear operator derived from spatial discretization of the regularization term in equation (7) and the A⁻¹ is the symbolic inverse of the operation. The equation (9) is the *iterative form that is performed within a loop till convergence. A multi-grid based successive over-relaxation method can be employed to compute the inverse operation [William L. Briggs, Van Emden Henson, and Steve F. MacCormick. A multigrid tutorial. SIAM, Society for Industrial and Applied Mathematics, 2. ed. edition, 2000].

The resulting deformation (initialized with zero) uₖⁱ, Step 128 and the process returns to Step 120 to determine whether there is convergence.

Thus, considering FIGS. 2A and 2B, for the rectum, for example, and energy function is determined that relates the degree such two regions match one another, i.e., relates the degree to which the image of the rectum in the. fixed image data set matches the rectum in the moving image data set as described above in equation (6).

The process then deforms the image data set of the rectum in the moving image data sets and by minimizing the energy function. This process is performed concurrently for the other regions, such as the bladder, in this example.

A number of embodiments of the invention have been described. Nevertheless, it will be understood that various modifications may be made without departing from the spirit and *scope of the invention. Accordingly, other embodiments are within the scope of the following claims.

What is claimed is:

1. A method for registration of two image data sets comprising:
compartmentalizing a first one of the two image data sets into a plurality of regions with each one of such regions having a corresponding region in the other one of the two image data sets;
for each one of the regions in the first one of the two image data sets and for the corresponding one of the regions in the other one of the two image data set, compute an energy function related to the degree such two regions match one another; and
minimizing the sum of the energy functions for each one of the regions in the first one of the two image data sets and for the corresponding one of the regions in the other one of the two image data set by deforming the image data set of such region in the other one of the image data set where the energy functions for each region is defined separately.

2. The method recited in claim 1 including extracting from each one of the regions in both the first image data set and the other image data set a intensity probability density function for such one of the regions;

3. The method recited in claim 2 wherein the energy function for a region is based on the defined probability density function, pdf as follows:
$${E}_{seg} ( T ) = - {\sum }_{i} {\int }_{{Φ}_{i}} log ( {p}_{i} ( {I}^{m} ( x + u ) ) ⅆ x$$
where:
pᵢ is a Gaussian distribution,
Φᵢ is the intensity of the area;
I^{m} is moving image
x is spatial coordinate of the fixed image
and
u is the deformation field.

4. The method recited in claim 3 wherein the minimize of the energy function for each one of the regions in the first one of the two image data sets and for the corresponding one of the regions in the other one of the two image data set by deforming the image data set of such region in the other one of the image data set are performed separately for each oe of the regions in the fist one of the two regions

5. The method recited in claim 1 wherein the minimization is performed for each one of the regions in each of the regions in the first image data set separately

6. The method recited in claim 1, wherein a similarity metric of various regions are defined as the integral or sum of the log of the probabilities of the pixel intensities of the region to be part of an a priori probability distribution function representing that region.

7. The method recited in claim 1, wherein the first one of the two image data sets, fixed image, represents a set of regions wherein a region specific similarity metric is defined as the integral or sum of the log of the probabilities of the pixel intensities of the region to be part a probability distribution function estimated from the outlined compartments of the fixed image.

8. The method recited in claim 1, wherein the first one of the two image data sets, the fixed image, represents a set of regions wherein a similarity metric is defined by a probabilistic framework involving an either a priori knowledge of estimated statistics from the fixed regions, where spatial positions are deliberately not considered.

9. The method recited in claim 1, wherein the first one of the two image data sets, the fixed image, represents a set of region wherein a similarity metric is defined by a probabilistic framework where radiometric properties are only considered.

10. The method recited in claim 8, where the solution is derived by solving an Euler Lagrange partial differential equations.

11. The method recited in claim 10, where the solution is derived by solving Euler Lagrange partial differential equations in an iterative setting using a full multi grid approach.
